(19) United States
(12) Patent Application Publication
(10) Pub. No.: US 2005/0228969 A1
(43) Pub. Date: Oct. 13, 2005

(54) Process for delivering very long instruction words to a processor and integrated circuit with an associated program memory device

(75) Inventors: Stephane Audrain, Grenoble (FR); Jean-Marc Gentit, Herbeys (FR)

Correspondence Address: JENKENS & GILCHRIST, PC, 1445 ROSS AVENUE, SUITE 3200, DALLAS, TX, 75202, US

(73) Assignee: STMicroelectronics S.A., Montrouge (FR)

(21) Appl. No.: 11/102,604

(22) Filed: Apr. 8, 2005

(30) Foreign Application Priority Data
Apr. 9, 2004 (FR) 04 03747

(51) Int. Cl. G06F 15/00

(52) U.S. Cl. 712/24; 712/210

(57) ABSTRACT

An integrated circuit includes a processor and a program memory device on a common substrate. The memory device is able to deliver to the processor VLIW instructions with at least m operative fields. The memory device comprises: a dictionary memory comprising dictionary instructions each having at least m dictionary elementary instructions; an instructions memory having primary instructions each associated with a VLIW instruction and containing its data, the address of a dictionary instruction, and m masking bits; and m selection devices respectively controlled by the masking bits and each delivering either an NOP instruction, or the dictionary elementary instruction corresponding to the masking bit, so as to reconstruct, by combination with the data of the primary instruction, the VLIW instruction.

### PRIORITY CLAIM

This application claims priority from French Application for Patent No. 04 03747 filed Apr. 9, 2004, the disclosure of which is hereby incorporated by reference.

### BACKGROUND OF THE INVENTION

1. Technical Field of the Invention

The present invention relates to in particular to program memories associated with processors, for example digital signal processors (DSP), operating with very long instruction words (VLIW), and more particularly integrated circuits incorporating such embedded processors together with their associated program memory. It is recalled that an embedded processor is, for example, produced jointly with other components by one and the same process and intended to be integrated together within an application specific integrated circuit (ASIC).

The invention applies advantageously but nonlimitingly to video processors.

2. Description of Related Art

The program memory of a VLIW processor is intended to comprise VLIW instructions. For example, the length of a VLIW instruction is 64 bits distributed into a 16-bit data field containing an “immediate value” (as it is customarily known to the person skilled in the art) and a collection of 48 bits comprising fields intended for the arithmetic unit (DCU), the addressing unit (ACU), and the sequencer (SEQ) of the processor.

The size of such a program memory is significant and it may represent up to half the size of the embedded processor, thereby constituting a major drawback.

A need exists in the art for a solution to this problem.

### SUMMARY OF THE INVENTION

Embodiments of the present invention propose a program memory device of reduced size, whose organization is reliant on the fact that out of the 2⁴⁸ possible instructions, for example, many are not used. Moreover, an instruction may be used several times in the course of one and the same program. The detection of these redundant instructions also makes it possible to reduce the size of the memory.

Accordingly, an embodiment of the invention proposes an integrated circuit comprising within one and the same substrate a processor, and a program memory device able to deliver to the processor a set of n very long instruction words, each very long instruction word comprising a first part (for example, at least certain bits of an immediate value) and a second part made up of at least m operative fields each containing an elementary instruction, (which may, for example, be of operative or else nonoperative (NOP) type).

The program memory device comprises a dictionary memory comprising p dictionary instructions, p being less than n, each dictionary instruction comprising at least m operative fields (m=3, for example) each containing a dictionary elementary instruction forming part of the collection of the elementary instructions. A dictionary elementary instruction may be an operative elementary instruction or else a nonoperative instruction (NOP).

The program memory device also comprises a memory for instructions comprising n primary instructions, each primary instruction being associated with a very long instruction word and comprising a first part corresponding to the first part of the very long instruction word, an address field containing the address of a dictionary instruction chosen having regard to the content of the second part of the said very long instruction word, and m masking bits respectively associated with the m operative fields of the dictionary instruction.

The memory device further comprises m selection means respectively controlled by the m masking bits and each delivering as a function of the value of the corresponding masking bit either a nonoperative elementary instruction or the dictionary elementary instruction contained in the corresponding operative field, the very long instruction word being reconstructed from the first part of the primary instruction and at least the outputs of the selection means.

Stated otherwise, an embodiment of the invention uses an “instruction compression” in combination with an instruction memory pointing to a dictionary memory and selection means controlled by masking bits. More precisely, if the code contains two or more identical instructions, this instruction is stored only once in the dictionary memory. This novel compression process is based on the fact that the VLIW instructions are formed of independent fields which are not all used each time an instruction is called. The dictionary instructions already stored in the dictionary memory are used, for example, by including an NOP instruction in place of the dictionary elementary instructions of the dictionary instruction which are not used in the VLIW instruction considered.

According to an embodiment at least one dictionary elementary instruction of each dictionary instruction is an operative elementary instruction.

The p dictionary instructions may be distributed into m distinct groups, each group containing dictionary instructions having one and the same number of operative elementary instructions.

Hence there will for example be a group of dictionary instructions comprising m (m=3, for example) operative elementary instructions, another group formed of dictionary instructions comprising m-1 operative elementary instructions and an NOP instruction, and so on and so forth up to a group comprising dictionary instructions with a single operative elementary instruction.

Moreover, the number of dictionary instructions containing k operative elementary instructions may be greater than the number of dictionary instructions containing k−1 operative elementary instructions, k varying from 2 to m.

When the first part of each very long instruction word comprises a data field containing a digital data word (immediate value), the latter may be stored entirely in the first part of the primary instruction associated with this very long instruction word and stored in the instruction memory.

According to a variant of the invention, the digital data word comprises a first portion contained in the first part of the primary instruction associated with this very long instruction word, and a second portion contained in the dictionary instruction designated by the address contained in the said primary instruction. The very long instruction word is reconstructed from the first part of the primary instruction, the outputs of the selection means, and the second portion contained in the designated dictionary instruction.

Preferably, the first portion of the digital data field comprises the low-order bits of the digital data and the second portion the high-order bits of the digital data.

In accordance with an embodiment of the invention, a process for delivering very long instruction words to a processor comprises:
a) a compilation of an executable program into a set of n very long instruction words, each instruction word comprising a first part and a second part comprising at least m operative fields each containing an elementary instruction,
b) the formulation and the storage in a dictionary memory of p dictionary instructions, p being less than n, each dictionary instruction comprising at least m operative fields each containing a dictionary elementary instruction forming part of the collection of the elementary instructions, and
c) the formulation and the storage in an instructions memory of n primary instructions, each primary instruction being associated with a very long instruction word and comprising a first part corresponding to the first part of the very long instruction word, an address field containing the address of a dictionary instruction chosen having regard to the content of the second part of the very long instruction word, and m masking bits respectively associated with the m operative fields of the dictionary instruction.

In an embodiment, the delivery of a very long instruction word furthermore comprises:
d) pointing to a primary instruction in the instructions memory,
e) addressing the dictionary instruction on the basis of the address contained in the pointed-at address field of the primary instruction,
f) selecting as a function of the state of the m masking bits of the pointed-at primary instruction, either a nonoperative elementary instruction or a dictionary elementary instruction contained in the corresponding operative field of the addressed dictionary instruction, and
g) reconstructing the very long instruction word on the basis of the first part of the primary instruction pointed at and of at least the elementary instructions selected.

In an embodiment, step b) may comprise the substeps:
b1) selecting the second parts of the very long instruction words obtained on completion of the compilation,
b2) eliminating the second redundant parts so as to retain a set of second parts, all mutually different,
b3) storing in the dictionary memory, in the guise of dictionary instructions the second parts comprising at least m operative elementary instructions, and
b4) examining successively the second parts comprising m-k operative elementary instructions, k varying successively from 1 to m-1, each examination comprising:
the elimination from the second parts examined of those that can be obtained on the basis of the dictionary instructions already stored in the dictionary memory,
the possible combination of certain remaining second parts, so as to obtain second parts comprising m-k+1 operative elementary instructions and storing them in the dictionary memory in the guise of dictionary instructions, and
the storage in the dictionary memory of the residual second parts.

In accordance with another embodiment, an integrated circuit comprises a first memory area storing dictionary instructions, certain dictionary instructions comprising a plurality of operative dictionary elementary instructions. A second memory area stores primary instructions, certain primary instructions including an address field identifying an address in the first memory of a dictionary instruction related to the primary instruction and also including a plurality of mask bits. A selection device receives the plurality of operative dictionary elementary instructions from the dictionary instruction addressed by the address field of the primary instruction, and forms a very long instruction word (VLIW) whose fields are populated by either certain ones of the received plurality of operative dictionary elementary instructions or a non-operative (NOP) instruction based on the values of the mask bits for the associated primary instruction.

In accordance with another embodiment, a method comprises storing in a first memory area dictionary instructions, certain dictionary instructions comprising a plurality of operative dictionary elementary instructions. The method further comprises storing in a second memory area primary instructions, certain primary instructions including an address field identifying an address in the first memory of a dictionary instruction related to the primary instruction and also including a plurality of mask bits. The plurality of operative dictionary elementary instructions are received from the dictionary instruction addressed by the address field of the primary instruction. Next, a very long instruction word (VLIW) is formed whose fields are populated by either certain ones of the received plurality of operative dictionary elementary instructions or a non-operative (NOP) instruction based on the values of the mask bits for the associated primary instruction.

### BRIEF DESCRIPTION OF THE DRAWINGS

Advantages and features of the invention will become apparent upon examining the detailed description of the methods and embodiments of the invention, which are in no way limiting, and the appended drawings in which:

FIG. 1 very diagrammatically illustrates an integrated circuit with a processor and an associated memory device, according to the invention;

FIG. 2 diagrammatically illustrates an exemplary very long instruction word (VLIW);

FIGS. 3 and 4 diagrammatically illustrate examples of VLIW instructions;

FIGS. 5 and 6 diagrammatically illustrate examples of primary and dictionary instructions according to the invention;

FIG. 7 represents an exemplary embodiment of a memory device according to the invention;

FIG. 8 diagrammatically illustrates an organization of a dictionary memory of a memory device according to the invention;

FIG. 9 represents a flowchart of a process for the processing of the dictionary instructions according to the invention;

FIGS. 10 and 11 illustrate more particularly substeps of a process for the processing of the dictionary instructions according to the invention; and

FIG. 12 presents a variant of the memory device according to the invention.

### DETAILED DESCRIPTION OF THE DRAWINGS

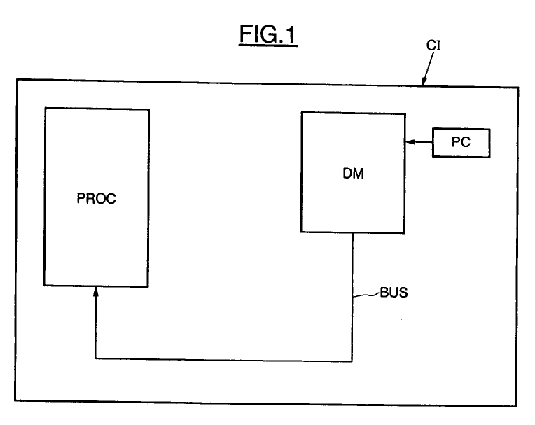

Represented in FIG. 1 is the integrated circuit CI of the device according to the invention. The reference PROC designates a processor connected to a memory device DM by way of a bus BUS. A program counter PC (according to the name customarily used by the person skilled in the art) points at the address of the memory device DM with the aim of delivering a VLIW instruction to the processor PROC, by way of the bus BUS. The integrated circuit CI can comprise a component part of a video processor system.

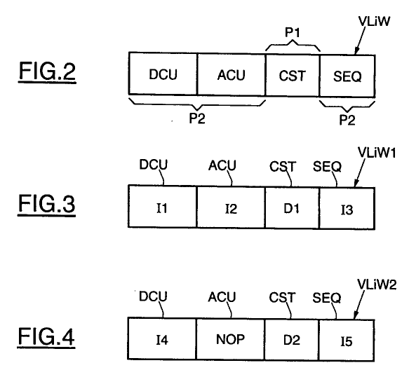

Referring to FIG. 2, a VLIW instruction comprises, in this example: a first part P1 comprising a digital data field CST and a second part P2 comprising three operative fields, each intended to contain an elementary instruction.

By way of indication, the field DCU is intended for instructions related to arithmetic operations. The field ACU is intended for instructions relating to addressing operations, and the SEQ field is intended for instructions relating to branch or control operations. Each of the fields DCU, ACU, SEQ can contain either an operative elementary instruction or a nonoperative instruction NOP.

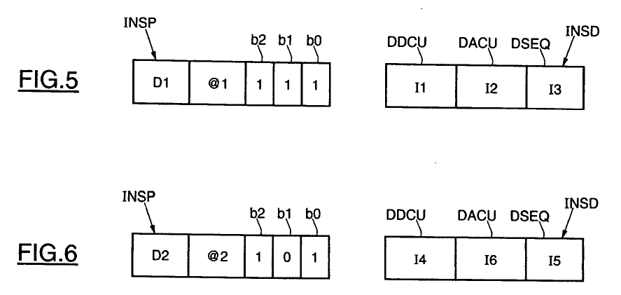

Thus, for example, FIG. 3 presents an instruction VLIW1 comprising three operative elementary instructions, respectively I1 for the DCU field, I2 for the ACU field and I3 for the SEQ field. The data field CST comprises a data item D1.

FIG. 4 presents an instruction VLIW2 whose DCU and SEQ fields contain operative elementary instructions I4 and I5 respectively. By contrast an NOP instruction is contained in the ACU field. The data field CST comprises a data item D2.

According to an embodiment of the invention, a VLIW instruction delivered to the processor from the memory device is formed from two types of instruction, a so-called primary instruction INSP and a so-called dictionary instruction INSD.

As will be seen in greater detail hereinafter, the dictionary instructions are stored in a dictionary memory, and the primary instructions in an instructions memory.

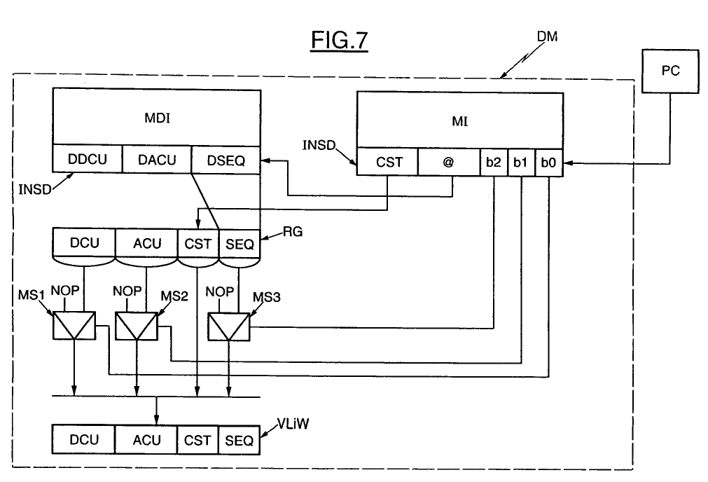

These two types of instructions are presented in FIG. 5. The dictionary instruction INSD comprises as many operative fields as the VLIW instruction. In this example, the dictionary instruction INSD therefore comprises three operative fields DDCU, DACU, DSEQ corresponding respectively to the three operative fields DCU, ACU and SEQ of the VLIW instruction presented in FIG. 2. The three operative fields each contain a dictionary elementary instruction belonging to the collection of elementary instructions of the VLIW instructions constituting the program. For example, the dictionary instruction INSD of FIG. 5 comprises, in each of its fields, an elementary instruction, I1, I2 and I3 respectively, of the VLIW instruction of FIG. 3.

Each primary instruction INSP is associated with an instruction VLIW. It comprises a data field containing data D1 corresponding to the data of the CST data field of the associated VLIW instruction, an address field containing the address in the dictionary memory of the dictionary instruction associated with the VLIW instruction and masking bits respectively associated with the operative fields of the dictionary instruction INSD. In this example, there are therefore three masking bits b2, b1 and b0 respectively associated with the fields DDCU, DACU, DSEQ.

So to formulate the VLIW instruction in FIG. 3, the primary instruction INSP in FIG. 5 contains in its data field, the data D1, in its address field, the address @1 of the dictionary instruction INSD presented in FIG. 5. This instruction INSD contains the elementary instructions I1, 12 and I3 of the VLIW instruction in FIG. 3. The masking bits b2, b1 and b0 each have the value “1” since all the dictionary elementary instructions of the dictionary instruction INSD are used to form the VLIW instruction considered.

FIG. 6 presents the primary instructions INSP and dictionary instructions INSD necessary to form the VLIW instruction presented in FIG. 4. Thus the primary instruction INSP contains in its data field, the data D2, in its address field, the address @2 of the dictionary instruction INSD presented in FIG. 6. The latter here contains, for example, the elementary instructions I4, I6 and I5. The masking bits b2, b1 and b0 have the values “1”, “0” and “1” respectively. In this way, the masking bits make it possible to select solely the instructions I4 and I5 of the dictionary instruction INSD so as to form the corresponding VLIW instruction of FIG. 4.

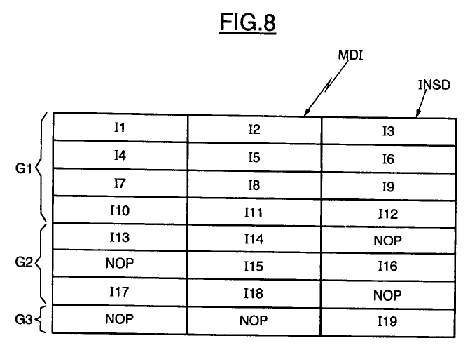

An exemplary architecture of the memory device DM adapted for the delivery of the VLIW instructions as described hereinabove is presented in FIG. 7. The memory device DM comprises a dictionary memory MDI for storing the dictionary instructions INSD. If after compilation the program code comprises n VLIW instructions, the dictionary memory MDI comprises p dictionary instructions, p being less than n.

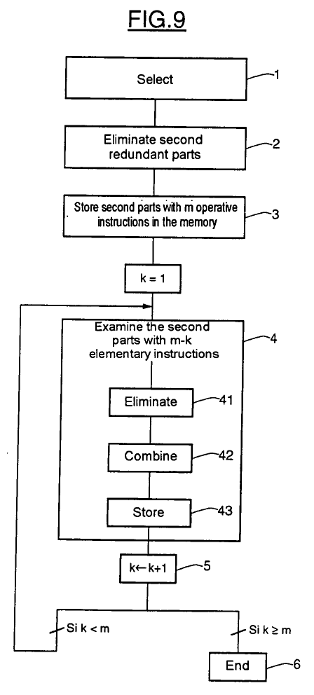

The dictionary instructions INSD are distributed as several distinct groups, three groups in this example. This distribution is presented in FIG. 8. A first group G1 comprises the dictionary instructions INSD made up of three operative dictionary elementary instructions. A second group G2 comprises the dictionary instructions INSD made up of two operative dictionary elementary instructions and of an NOP instruction. A third group G3 comprises the dictionary instructions INSD made up of an operative dictionary elementary instruction and two elementary NOP instructions. The number of instructions contained in the group G1 is in general greater than the number of instructions of the group G2 which is itself in general greater than the number of instructions of the group G3. The means of achieving this organization of the dictionary memory MDI will be described hereinafter.

The memory device DM of FIG. 7 also comprises an instructions memory MI wherein are stored the primary instructions INSP. The number of primary instructions is equal to n (number of VLIW instructions of the program code). A primary instruction INSP associated with a VLIW instruction to be delivered is designated by the program pointer PC. The instructions memory MI then points to the dictionary instruction INSD designated by the address contained in the address field of the primary instruction INSP designated by the pointer PC.

The designated dictionary instruction INSD then delivers its dictionary elementary instructions into a register RG and the associated primary instruction INSD delivers to the same register RG the data contained in its data field CST.

The register RG then delivers the elementary instructions to selection means MS1, MS2 and MS3 which furthermore receive as input an NOP instruction. Each selection means (duplexer) is controlled by a masking bit of the primary instruction INSP respectively b0, b1 and b2. Depending on the value of the masking bit “1” or “0”, the selection means MSi delivers either the elementary instruction received as input or an NOP instruction.

The VLIW instruction to be delivered is then formulated with the outputs of the selection means MSi and the data emanating directly from the CST field of the resister RG.

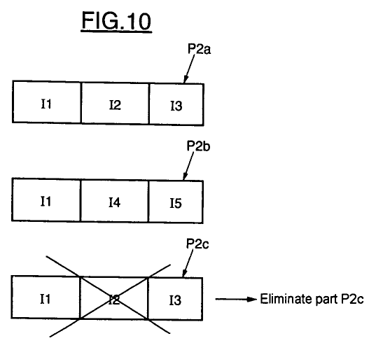

A process for formulating and storing the dictionary elementary instructions in the dictionary memory MDI will now be described in greater detail. The flowchart of FIG. 9 illustrates the main steps thereof.

In FIG. 2, a VLIW instruction emanating from the compilation of the program code comprises a first part PI (CST field) and a second part P2 formed of the operative fields DCU, ACU and SEQ.

The first step (step 1) consists in selecting with a view to their examination the second parts P2 of the VLIW instructions obtained on completion of compilation.

Next (step 2), the P2 redundant parts are eliminated so as to retain a set of second parts P2, all mutually different.

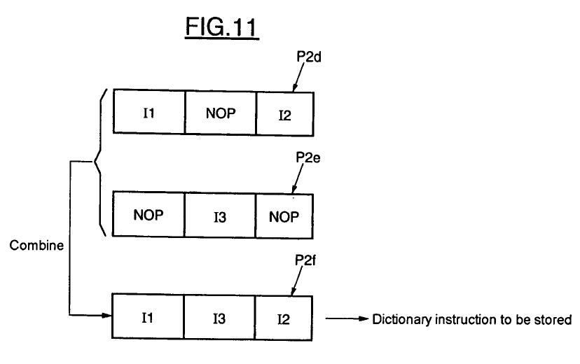

For example, in FIG. 10 are illustrated three parts P2a, P2b, P2c emanating from the three VLIW instructions after compilation. The parts P2a and P2c are identical (or redundant). Therefore, the part P2c is, for example, eliminated, retaining only the parts P2a and P2b.

The second parts P2 made up only of operative elementary instructions with no NOP instruction, that is to say in this example, m (for example, =3) operative elementary instructions, are then stored (step 3) in the dictionary memory MDI, in the guise of dictionary instructions INSD.

The second parts of the VLIW instructions made up of 3-k operative elementary instructions, k varying successively, in this example, from 1 to 2, are then examined in succession (step 4).

Each examination comprises the substeps described hereinafter.

First, the second parts examined P2, that may be obtained on the basis of the dictionary instructions INSD already stored in the dictionary memory MDI, are eliminated (step 40). Specifically, as we have described in FIGS. 5 and 6, a VLIW instruction can be reconstructed by selecting the necessary elementary dictionary instructions already stored with the aid of the masking bits of the primary instruction INSP.

The possible combination of certain remaining second parts (step 41) is then carried out, so as to obtain second parts P2 made up of m-k+1 operative elementary instructions and store them in the dictionary memory MDI in the guise of dictionary instructions INSD.

For example, FIG. 11 represents two parts P2d and P2e each comprising two operative elementary instructions and one NOP instruction. The part P2d comprises an elementary instruction I1, a nonoperative elementary instruction NOP and an elementary instruction I2. The part P2e comprises a nonoperative elementary instruction NOP, an elementary instruction I3, a nonoperative elementary instruction NOP. Thus, these two parts P2d and P2e can be combined and the part P2f comprising the elementary instructions I1, I3 and I2 can be stored in the dictionary memory MDI in the guise of dictionary instruction INSD. The parts P2d and P2e can be formulated subsequently from the part P2f and the suitable values of the masking bits b2, b1 and b0.

Next, the residual second parts P2 of the VLIW instructions are stored in the dictionary memory MDI (step 42), that is to say the second parts P2 (comprising for example two operative instructions) that cannot be combined with other second parts P2 comprising the same number of operative instructions.

The value of k is then incremented (step 5), and substeps 40 to 42 are then repeated as long as k is strictly less than the number of operative fields of a VLIW instruction, three in this example. In the converse case, the procedure for formulating and storing the instructions in the dictionary memory MDI is terminated (step 6).

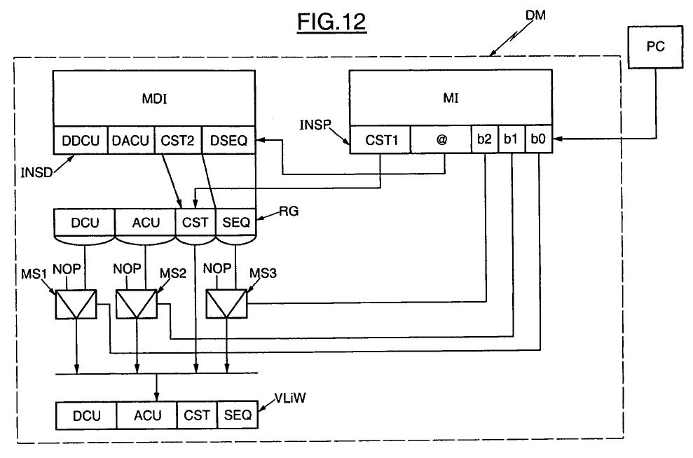

FIG. 12 presents a variant of the invention presented in FIG. 7.

The digital data word of a VLIW instruction comprises two distinct portions. The first portion may for example contain the low-order bits of the digital data word and the second portion the high-order bits of this same digital data word.

Upon the storage of this digital data word, the first portion of the said digital data word is contained in the first part of the primary instruction INSP associated with this VLIW instruction, that is to say the field CST1. The second portion CST2 of the said digital data word is contained in the dictionary instruction designated by the address of the address field of the said primary instruction INSP.

Thereafter, when the VLIW instruction is reconstructed, the first part of the said primary instruction INSP, the outputs of the selection means MS1, MS2 and MS3, and the said second portion contained in the said designated dictionary instruction INSD are associated.

The invention also allows for example a 50% reduction in the program memory and consequently a 25% reduction in the surface area of the integrated circuit. More precisely, for example, the size of the program memory according to the invention corresponds to an instruction size of less than 31 bits as against 64 bits in the prior art.

The present invention is not limited to the examples described above. Many variant embodiments are possible without departing from the scope of the invention defined by the appended claims.

1. An integrated circuit comprising,
within one and the same substrate:
a processor; and
a program memory device able to deliver to the processor a set of n very long instruction words, each very long instruction word comprising a first part and a second part made up of at least m operative fields each containing an elementary instruction, wherein the program memory device comprises:
a dictionary memory comprising p dictionary instructions, p being less than n, each dictionary instruction comprising at least m operative fields each containing a dictionary elementary instruction forming part of the collection of the elementary instructions,
a memory for instructions comprising n primary instructions, each primary instruction being associated with a very long instruction word and comprising a first part corresponding to the first part of the very long instruction word, an address field containing the address of a dictionary instruction chosen having regard to the content of the second part of the very long instruction word, and m masking bits respectively associated with the m operative fields of the dictionary instruction, and
m selection means respectively controlled by the m masking bits and each delivering as a function of the value of the corresponding masking bit either a nonoperative elementary instruction or the dictionary elementary instruction contained in the corresponding operative field, the very long instruction word being reconstructed from the first part of the said primary instruction and at least the outputs of the selection means.

2. The integrated circuit according to claim 1, wherein at least one dictionary elementary instruction of each dictionary instruction is an operative elementary instruction.

3. The integrated circuit according to claim 2, wherein the p dictionary instructions are distributed into m distinct groups, each group containing dictionary instructions having one and the same number of operative elementary instructions.

4. The integrated circuit according to claim 3, wherein the number of dictionary instructions containing k operative elementary instructions is greater than the number of dictionary instructions containing k-1 operative elementary instructions, k varying from 2 to m.

5. The integrated circuit according to claim 1, wherein the first part of each very long instruction word comprises a data field containing a digital data word, the latter being stored entirely in the first part of the primary instruction associated with this very long instruction word and stored in the instruction memory.

6. The integrated circuit according to claim 1, wherein the first part of each very long instruction word comprises a data field containing a digital data word, and wherein the digital data word comprises a first portion contained in the first part of the primary instruction associated with this very long instruction word, and a second portion contained in the dictionary instruction designated by the address contained in the primary instruction, and wherein the very long instruction word is reconstructed from the first part of the said primary instruction, the outputs of the selection means, and the second portion contained in the designated dictionary instruction.

7. The integrated circuit according to claim 6, wherein the first portion of the digital data field comprises the low-order bits of the digital data and the second portion the high-order bits of the digital data.

8. The integrated circuit according to claim 1 wherein that integrated circuit is incorporated within a video processor system.

9. A process for delivering very long instruction words to a processor, comprising:
a) a compilation of an executable program into a set of n very long instruction words, each instruction word comprising a first part and a second part comprising at least m operative fields each containing an elementary instruction,
b) the formulation and the storage in a dictionary memory of p dictionary instructions, p being less than n, each dictionary instruction comprising at least m operative fields each containing a dictionary elementary instruction forming part of the collection of the said elementary instructions,
c) the formulation and the storage in an instructions memory of n primary instructions, each primary instruction being associated with a very long instruction word and comprising a first part corresponding to the first part of the said very long instruction word, an address field containing the address of a dictionary instruction chosen having regard to the content of the second part of the said very long instruction word, and m masking bits respectively associated with the m operative fields of the dictionary instruction,
and wherein the delivery of a very long instruction word comprises:
d) pointing to a primary instruction in the instructions memory,
e) addressing the dictionary instruction on the basis of the address contained in the pointed-at address field of the said primary instruction,
f) selecting as a function of the state of the m masking bits of the pointed-at primary instruction, either a nonoperative elementary instruction or a dictionary elementary instruction contained in the corresponding operative field of the addressed dictionary instruction,
g) reconstructing the very long instruction word on the basis of the first part of the said primary instruction pointed at and of at least the elementary instructions selected.

10. The process according to claim 8, wherein step b) comprises the substeps:
b1) selecting the second parts of the very long instruction words obtained on completion of the compilation,
b2) eliminating the second redundant parts so as to retain a set of second parts, all mutually different,
b3) storing in the dictionary memory, in the guise of dictionary instructions the second parts comprising at least m operative elementary instructions,
b4) examining successively the second parts comprising m-k operative elementary instructions, k varying successively from 1 to m-1, each examination comprising:
the elimination from the second parts examined of those that can be obtained on the basis of the dictionary instructions already stored in the dictionary memory, the possible combination of certain remaining second parts, so as to obtain second parts comprising m-k+1 operative elementary instructions and storing them in the dictionary memory in the guise of dictionary instructions,
the storage in the dictionary memory of the residual second parts.

11. An integrated circuit, comprising:
a first memory area storing dictionary instructions, certain dictionary instructions comprising a plurality of operative dictionary elementary instructions;
a second memory area storing primary instructions, certain primary instructions including an address field identifying an address in the first memory of a dictionary instruction related to the primary instruction and also including a plurality of mask bits; and
a selection device that receives the plurality of operative dictionary elementary instructions from the dictionary instruction addressed by the address field of the primary instruction, the selection device forming a very long instruction word (VLIW) whose fields are populated by either certain ones of the received plurality of operative dictionary elementary instructions or a non-operative (NOP) instruction based on the values of the mask bits for the associated primary instruction.

12. The circuit of claim 11 wherein the plurality of operative dictionary elementary instructions comprise an arithmetic operation instruction, an addressing operation instruction and a branch/control operation instruction, the mask bits specifying which of these instructions are to be used in populating fields of the very long instruction word.

13. The circuit of claim 11 wherein the certain primary instructions further include a digital data field, the selection device further forming the very long instruction word by populating an included field with the digital data field for the associated primary instruction.

14. The circuit of claim 13 wherein the certain dictionary instructions further include an additional digital data field, the selection device further forming the very long instruction word by populating an included field with the digital data field for the associated primary instruction and the additional data field from the dictionary instruction addressed by the address field of the primary instruction.

15. The circuit of claim 11 wherein the memory is included as an embedded memory with a processor which accesses the embedded memory.

16. The circuit of claim 15 wherein the embedded memory and processor for at least a portion of an application specific integrated circuit.

17. The circuit according to claim 11 wherein that integrated circuit is incorporated within a video processor system.

18. A method, comprising:
storing in a first memory area dictionary instructions, certain dictionary instructions comprising a plurality of operative dictionary elementary instructions;
storing in a second memory area primary instructions, certain primary instructions including an address field identifying an address in the first memory of a dictionary instruction related to the primary instruction and also including a plurality of mask bits;
receiving the plurality of operative dictionary elementary instructions from the dictionary instruction addressed by the address field of the primary instruction;
forming a very long instruction word (VLIW) whose fields are populated by either certain ones of the received plurality of operative dictionary elementary instructions or a non-operative (NOP) instruction based on the values of the mask bits for the associated primary instruction.

19. The method of claim 18 wherein the plurality of operative dictionary elementary instructions comprise an arithmetic operation instruction, an addressing operation instruction and a branch/control operation instruction, the mask bits specifying which of these instructions are to be used in populating fields of the very long instruction word.

20. The method of claim 18 wherein the certain primary instructions further include a digital data field, forming further comprising forming the very long instruction word by populating an included field with the digital data field for the associated primary instruction.

21. The method of claim 20 wherein the certain dictionary instructions further include an additional digital data field, forming further comprising forming the very long instruction word by populating an included field with the digital data field for the associated primary instruction and the additional data field from the dictionary instruction addressed by the address field of the primary instruction.
